(19) United States
(12) Patent Application Publication
(10) Pub. No.: US 2009/0313112 A1
(43) Pub. Date: Dec. 17, 2009

(54) COOKWARE RECYCLING PROCESS

(76) Inventors: Susanne Champ, Chicago, IL (US); Dave M. Lew, Mableton, GA (US); Michael J. Otterman, Kildeer, IL (US)

Correspondence Address: GARDNER GROFF GREENWALD & VILLANUEVA, PC, 2018 POWERS FERRY ROAD, SUITE 800, ATLANTA, GA, 30339, US

(21) Appl. No.: 12/486,460

(22) Filed: Jun. 17, 2009

Related U.S. Application Data
(60) Provisional application No. 61/073,037, filed on Jun. 17, 2008.

(51) Int. Cl. G06Q 30/00; G06Q 99/00; G06Q 10/00; G06Q 90/00; G06Q 50/00

(52) U.S. Cl. 705/14.39; 705/1; 705/30; 705/500

(57) ABSTRACT

A method for performing a redemption transaction involves purchasing of new retail cookware, sending used/recyclable cookware to a vender-designated recycling facility, and forwarding a customer bonus item in exchange for the recyclable cookware. The recyclable cookware can be returned in the new cookware retail packaging. The consumer accesses a vender website to select a bonus item and to print out a shipping label for returning the recyclable cookware. The shipping label includes a unique redemption identifier. Upon receipt of the recyclable cookware, the vender facility forwards a customer bonus item to the customer based upon customer preferences and the amount/type of recyclable material returned.

### CROSS-REFERENCE TO RELATED APPLICATION

This application claims the priority benefit of U.S. Provisional Patent Application Ser. No. 61/073,037, filed Jun. 17, 2008, which is hereby incorporated herein by reference.

### TECHNICAL FIELD

The present invention relates generally to recyclable metallic cookware and, in particular, to methods for encouraging and facilitating consumer participation in the recycling of used metallic cookware.

### BACKGROUND

The importance of recycling continues to rise as the population increases and natural resources become scarcer. The typical consumer utilizes a variety of household goods in day-to-day life that can be efficiently recycled. Paper and plastics are already the subject of recycling programs in most metropolitan communities. Electronic goods such as cell phones, batteries, and computers have also been the focus of recycling efforts in most areas. However, one common household item that is not known to be the subject recycling programs is metallic cookware.

Many traditionally metallic products have been replaced in the modern household by designs featuring plastic or synthetic materials. One consumer product that is still commonly made of metallic materials is cookware such as pots and pans. The material used in metallic pot and pan construction is typically a high grade of a relatively pure metal composition. The material traditionally used for cookware construction was cast iron. But the modern consumer now enjoys cookware made from a variety of metal alloys such as aluminum, magnesium, brass, and copper.

In a typical household, if a consumer desires to recycle cookware, the consumer places the used cookware in with all other recyclable goods of the family. The consumer must them transport the recyclable materials to an appropriate location for pick-up or transport to a recycling facility. A downstream recycling facility must then sort the consumer's mix of materials and identify the value of the metal that was used in the cookware manufacture. The recycling facility must then forward the cookware to an appropriate metal recycler for use in other products. As such, the consumer realizes no direct benefit related to recycling the old cookware, so even if the consumer chooses to recycle, the consumer is somewhat detached from the recycling process.

Accordingly, it can be seen that a need exists for a recycling program that is specifically directed to used cookware items. It is to such a used cookware recycling method and system that the present invention is primarily directed.

### SUMMARY

The disadvantages of the prior art are overcome by the present invention which, generally described, relates to methods and systems for encouraging and facilitating participation in the recycling of used metallic cookware. The process can be carried out by consumers or by other cookware users such as restaurants.

In one aspect, the invention provides a method for performing a redemption transaction involving the purchase of new retail cookware by a consumer (or restaurant or other cookware user), the return of recyclable cookware by the consumer to a vender-designated recycling facility, and the forwarding of a customer bonus item to the consumer in exchange for the recyclable cookware. In an example embodiment, the method includes the steps of the purchase by the consumer of a new retail cookware item offered by a vender. The retail cookware item is supplied in a vender retail package. The consumer removes the new retail cookware item, places the recyclable cookware into the vender retail package, and seals the package. The recyclable cookware is then shipped within the vender retail package to a vender designated-recycling facility. The receipt of the recyclable cookware within the vender designated facility is recorded. And finally, a bonus item is forwarded to the consumer by the vender.

In another aspect of the present invention, the return shipment of the recyclable cookware to the vender-designated facility includes the consumer accessing the vender website using a personal computer (or other communications device such as a laptop, a cell phone, or a PDA) on a global computer network (such as the Internet or a cellular network). On the vender website, the consumer enters personal data and purchase data relevant to the purchase of the new retail cookware item within a vender application. The vender application stores the consumer's personal and purchase data within a vender database and assigns a unique redemption identifier relevant to the consumer personal and purchase data. The vender application stores the redemption identifier in the vender database and sends it to the consumer. The consumer then receives and prints the unique redemption identifier and a shipping label from the vender application. The consumer affixes the unique redemption identifier and the shipping label to the vender retail package.

In another aspect of the present invention, the unique redemption identifier includes an alpha-numerical number, a barcode, or a combined alpha-numeric number and barcode. The consumer personal data includes the consumer's name and the consumer's mailing address. The consumer personal data might further include the consumer's age, the consumer's marital status, the number of members of the consumer's household, and/or the consumer's cooking habits. The consumer personal data can also include a selection of a bonus item. The bonus items that can be selected may include cash, a tax receipt for the value of the recycled material, a coupon for future purchases, a special non-retail cookware item, a cookware item made from the metal of previously recycled cookware, another bonus, or some combination thereof.

In another aspect of the present invention, the consumer purchase data includes the type/model of retail cookware item purchased. The consumer purchase data can further include the date of purchase of the retail cookware, the retail distributor where the vender cookware was purchased, and/or the price paid for the retail cookware.

In yet another aspect of the present invention, receiving the recyclable cookware by the vender-designated facility includes scanning the unique redemption identifier on the retail package, obtaining recycle data relevant to the recyclable cookware and retail package, entering the recycle data into the vender application, and the vender application storing the redemption identifier and recycle data in the vender database. The recycle data may include a verification of the presence of a recyclable cookware item within the retail package, the weight of the recyclable cookware returned, the weight of the combined retail package and recyclable cookware, and/or the quantity of recyclable cookware items within the retail package. The recycle data may further include the retail cookware item purchased as reflected on the vender retail package, the brand of cookware returned for recycling, and/or the type/model of cookware returned for recycling. Finally, the recycle data can include the type of metal from which each item of recyclable cookware is made.

In yet another aspect of the present invention, the forwarding of a bonus item to the consumer by the vender includes receiving a unique redemption identifier by the vender application from the vender-designated facility, verifying compliance by the vender application of the retail cookware item purchase by comparing the recycle data, to program requirements, generating correspondence to the consumer by the vender application that is specific to the consumer personal data and purchase data, and shipping a bonus item and the correspondence to the consumer. The bonus item can be pre-selected by the consumer.

In yet another aspect, the present invention provides a method for performing a redemption transaction involving the purchase of new retail cookware, the return of recyclable cookware by a consumer to a vender-designated facility, and the forwarding of a customer bonus item to the consumer in exchange for the recyclable cookware. The method includes the purchase by the consumer of a new retail cookware item offered by a vender. The retail cookware is supplied in a vender retail package. The consumer removes the new retail cookware item, places the recyclable cookware into the vender retail package, and seals the package. The recyclable cookware is shipped, within the vender retail package, to a vender-designated facility for recycling. The recyclable cookware is then received by the vender-designated facility. The recyclable cookware is smelted to extract its metallic constituent materials, which are then cast into metal components. And then the metal components are forwarded to the consumer as a bonus item. The receipt of the recyclable cookware by the vender-designated recycling facility can include obtaining recycle data relevant to the recyclable cookware received from the consumer. The recycle data can include the weight of the recyclable cookware returned, the weight of the combined retail packaging and recyclable cookware, and/or the quantity of recyclable cookware items within the retail package. The recycle data may also include the type of metal from which each item of recyclable cookware is made. The consumer bonus item for forwarding to the consumer is then selected from a group based upon a component of the recycle data.

The specific techniques and structures employed by the invention to improve over the drawbacks of the prior art and accomplish the advantages described herein will become apparent from the following detailed description of the example embodiments and the appended drawings and claims.

### BRIEF DESCRIPTION OF THE DRAWINGS

The accompanying drawings are not intended to be drawn to scale. In the drawings, each identical, or nearly identical component that is illustrated in various figures is represented by a like numeral. For purposes of clarity, not every component may be labeled in every drawing.

FIG. 1A is a block diagram depicting a method of cookware recycling in accordance with an example embodiment of the present invention.

FIG. 1B is a block diagram depicting a system for cookware recycling in accordance with an example embodiment of the present invention.

FIG. 2 is a flow diagram depicting consumer actions in a cookware recycling process in accordance with an example embodiment of the present invention.

FIG. 3 is a flow diagram depicting vender actions in cookware recycling process in accordance with an example embodiment of the present invention.

FIG. 4 is a flow diagram depicting further vender actions in a cookware recycling process in accordance with an example embodiment of the present invention.

### DETAILED DESCRIPTION OF EXAMPLE EMBODIMENTS

In accordance with an example embodiment of the present invention, a process for performing a redemption transaction involving the recycling of used cookware is provided. The process involves a consumer (e.g., or restaurant or other cookware user) purchasing a vender's new cookware, the consumer returning used/recyclable cookware in the vender packaging of the new cookware to a vender facility, and the vender forwarding a bonus item to the consumer in exchange for the used/recyclable cookware.

Used cookware presents a unique opportunity in metal recycling. Cookware items typically include a cooking vessel and a handle attached to it, with the vessel made of a metal alloy and the handle made of another metal alloy. Each cookware item represents a large amount of recyclable metal relative to other common metallic household goods. Disassembly and sorting of the cookware by its component metal types is relatively easy when compared to a complex machine with many components of varying metals. Moreover, the alloys used in modern cookware are substantially more valuable in the scrap metal market than the traditional cast iron material or than the average metal scrap of a consumer household. The relatively high value of the cookware scrap metal makes recycling cookware not only more environmentally friendly, but also a viable and potentially profitable process for the metal recycler.

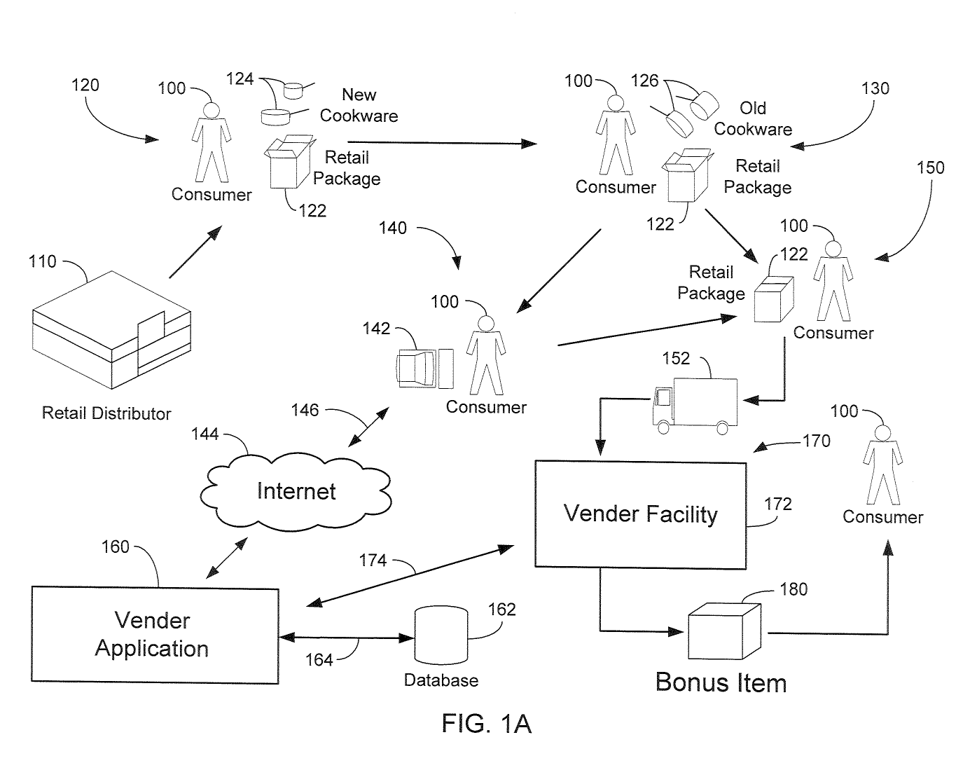

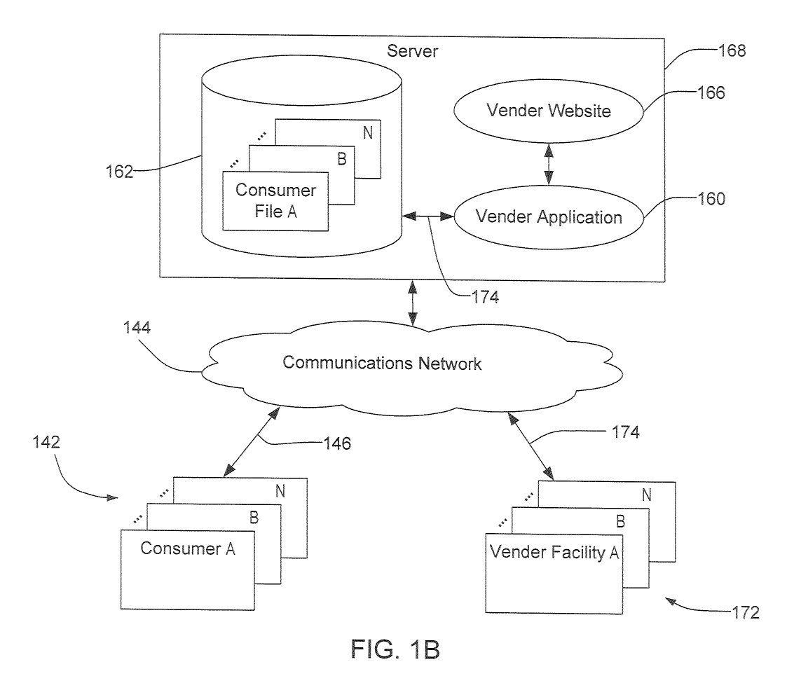

With reference to the figures, in which like numerals represent like elements throughout, FIGS. 1A and 1B are a block diagrams depicting an example method and system of cookware recycling in accordance with one embodiment of the present invention. In FIG. 1A, the consumer is depicted as a stick FIG. 100. The consumer shops (online or physically) at a retail distributor 110, and selects and purchases new cookware 124 from a particular vender (e.g., the cookware manufacturer, a department store, a specialty cookware store, or another type of retailer). The new cookware 124 can be one or more pots, pans, griddles, woks, kettles, platters, and/or the like, and/or cookware accessories such as tongs, spatulas, and the like, whether purchased individually or as a set.

At 120, the consumer 100 brings the retail cookware purchase home and removes the new cookware 124 from the vender retail packaging 122. The consumer 100 is alerted to the used cookware recycling opportunity by insert materials accompanying the new cookware 124. The insert materials include directions and program requirements for the consumer 100 to recycle the used cookware and receive an award of a bonus item. In an alternative embodiment, the consumer may be alerted to the cookware recycling opportunity by printed materials on the outside of the retail package, by point-of-sale advertisements at the retail location or website, by print advertisements by the vender, by direct mail or email advertisements by the vender, or by other means as are known to those skilled in the advertising arts.

At 130, the consumer 100 selects its used cookware 126 that it wants to redeem in the recycling process. The used cookware 126 can be one or more pots, pans, griddles, woks, kettles, platters, and/or the like, and cookware accessories such as tongs, spatulas, and the like, whether purchased individually or as a set. The used cookware 126 selected for recycling can be of the same type as the new cookware 126 (e.g., a new frying pan and a used frying pan) or of a different type (e.g., a used steaming pot and a new sauce pot). In addition, the used cookware 126 selected for recycling and the new cookware 126 purchased can be of the same approximate size/shape and quantity, or fewer and/or smaller used cookware items can be returned for recycling than were purchased. Alternatively, if the retail packaging is not large enough for containing the used cookware to be returned, then the consumers can provide their own packaging for returning the used cookware for recycling. In any event, the consumer places the old cookware 126 into the vender retail packaging 122 that carried the new cookware 124 purchased. The consumer follows instructions provided by the insert materials for packing the old cookware 126 within the retail packaging 122 and sealing the package for shipment.

At 140, the consumer 100 accesses a vender application 160, via the vender's website (or a proxy therefor such as the retailer's website) using a computer 142 (or another communications device such as a cell phone or PDA), the Internet 144 (or another communications network such as a cellular network), and an Internet interface 146 (or another communications network connection). The consumer 100 inputs personal information and information regarding the purchase of the new cookware 124 to the vender application 160. The vender application 160 stores the consumer information in a database 162 via a datalink 164, assigns a unique redemption identifier, and associates the unique redemption identifier with the particular consumer and purchase data. The unique redemption identifier can include an alpha-numerical number, a barcode, or a combined alpha-numeric number and barcode. The vender application 160 also generates a shipping label for download by the consumer 100 that displays the unique redemption identifier and a shipping address for the used cookware 126 to be sent to a vender-designated location.

Alternatively, the shipping label and the unique redemption identifier can be provided separately. For example, the shipping label can be provided within the original retail packaging and the redemption identifier can be generated by the vender application 160. In another embodiment, the original retail packaging includes an insert including the mailing label and a unique identifier (e.g., a barcode) for that package. In this embodiment, the vender application 160 need not generate a new redemption identifier. Instead, upon the vender facility later receiving the package containing the used cookware (as described below), the vender application 160 accesses a file in the database associated with the package identifier and uses that same identifier as the redemption identifier (or as a root or other portion of it). The file can include the type and quantity of the new cookware that was in the retail package, so that information need not be entered by the consumer.

At 150, the consumer 100 places the shipping label with the integral redemption identifier (as provided by the vender application 160) onto the retail package 122. The consumer 100 then arranges or enables shipment 152 of the recyclable cookware 126 in accordance with the vender instructions. At 170, the retail packaging 122 and enclosed used cookware 126 are received at the vender-designated facility 172. The unique redemption identifier is recorded (e.g., scanned) from the retail packaging 122, and the recyclable cookware 126 is removed from the retail packaging.

The vender-designated facility 172 then accesses the vender application 160 via network interface 174 and transmits to it the redemption identifier information. The vender application 160 verifies the consumer identity and program compliance, and transfers instructions back to the vender facility 172 for the shipment of a bonus item 180. The vender facility 172 then ships the bonus item 180 to the consumer 100 as a redemption award for participating in the cookware recycling program.

Before continuing with other aspects of the recycling method, additional details of the recycling system used in the recycling method will be described with reference to FIG. 1B. The vender application 160, the database 162, the vender website 166, and other conventional software elements are stored on one or more data storage devices such as magnetic or optical disk drives on a server computer 168. The additional software elements can include an element for registering new consumer users who have not used the recycling method before, storing user identifications and passwords in the consumer files, and permitting previous users to enter their user identification and password to access the application. The consumer data (including the user identification and password) and the purchase data are stored in consumer files on the database 162. The server 168 is connected to the Internet 144 (or another communications network) and accessible by the consumer's computer 142 (or another communications device) and by a computer (or another networked communications device) of the vender facility 172. In an embodiment in which the server 168 is located at or near the vender facility 172, the vender facility can be connected to the server by a local area network.

As persons skilled in the networked-computing art can appreciate, the vender application 160, the database 162, and the vender website 166 are shown in a conceptual manner for purposes of illustration and may not reside in memory simultaneously or in their entireties. Rather, in the manner in which networked computers are known to operate, these software elements (and other conventional software elements) or portions thereof can be distributed and stored on one or more remote data storage devices and retrieved on an as-needed basis via a network interface (e.g., an Internet connection). In other embodiments, the functions of the vender application 160, the database 162, the vender website 166, and other software elements can be distributed over a greater number of software elements. Servers hosting websites and applications are well understood by persons skilled in the networked-computing art, therefore the underlying principles, algorithms, data structures, etc., are not described in detail herein.

The computers (or other communications devices) of the consumer 100 and the vender-designated facility 172 can each comprise a general-purpose computer such as a personal computer. Such a computer includes a programmed processor system, a display, a keyboard, mouse or similar pointing device, a network interface, a fixed-medium data storage device such as a magnetic or optical disk drive, and a removable-medium data storage device such as a CD-ROM or DVD drive. Other elements commonly included in personal computers can also be included. The programmed processor system includes one or more processors, memories, and other logic that together define the overall computational and data manipulation power of the computer.

Although in the example embodiment the computers comprise personal computers or similar general-purpose computers, in other embodiments they can comprise any other suitable computer type. In some embodiments, portions of such computers can be distributed among a number of networked computers. The data storage devices store software elements (e.g., an operating system, a graphical user interface, utilities, and device drivers) that can alternatively be stored in a distributed manner and retrieved via the network interface from multiple sources on an as-needed basis. In view of the descriptions herein, persons skilled in the computing art will be readily capable of providing suitable software and otherwise programming or configuring the consumer and vender facility computers to perform the methods described herein.

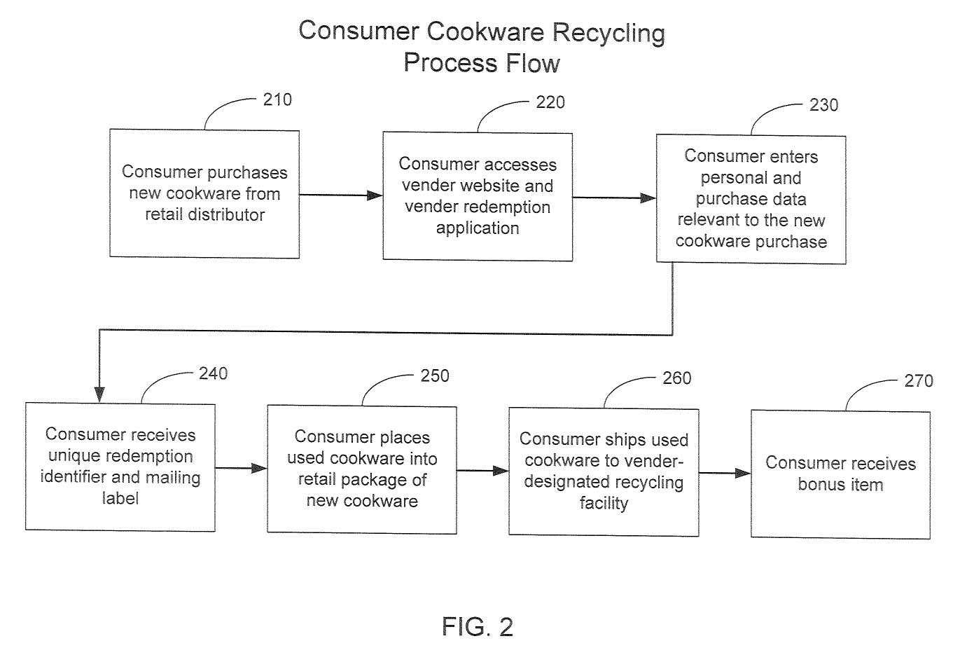

The consumer perspective to the cookware recycling process is presented in FIG. 2, which is a flow diagram depicting consumer actions in a process flow in accordance with an example embodiment of the present invention. At 210, the consumer purchases new cookware from a retail distributor. The retail distributor may be a department store, a vender of specialty cookware products, or the vender or manufacturer itself. The retail distributor can offer the new cookware for purchase, and the consumer can purchase it, in a physical store and/or online. The consumer selects the new cookware of interest and executes the purchase.

At 220, the consumer has been made aware of the cookware recycling program by point-of-sale advertisements, packaging inserts, or other means as described above. The consumer uses a communications device (e.g., an Internet-connected personal computer or laptop, or a cell phone) to access a vender application via a vender website, and receives from the vender application instructions on participation in the vender cookware recycling program.

At 230, in response to prompts by the vender application, the consumer enters personal data such as the consumer's name, mailing address, shipping address, age, marital status, number of household members, cooking habits, and/or other information that may be of interest to the new-cookware vender. In one embodiment, the vender application allows the consumer to select a preferred bonus item from a menu of bonus-item selections. The bonus-item selections can include, but are not limited too, a check from the vender, a tax receipt for the value of the recycled material, a coupon for future purchases of the vender's items, a special vender cookware item not otherwise available for purchase, a vender cookware item that is at least partially made from the metal of the used cookware being recycled, another gift (e.g., a recycling-related gift such as a reusable shopping bag made of recycled materials), or some combination of the above. In an alternative embodiment, the consumer may not receive any bonus item for recycling, or may only receive an acknowledgement or a thank you letter for recycling as a reward for their efforts. In any event, the value of the bonus item is less than, and not necessarily proportional to, the value of the recyclable cookware returned.

In response to additional prompts by the vender application, the consumer additionally enters purchase data such as the type/identity (e.g., model number) of the new cookware item purchased, the date of the purchase, the retail distributor where the cookware was purchased, the price paid, and/or other purchase information that may be of interest to the new-cookware vender. The vender application can be designed to present the consumer with a text or pictorial listing of the vender's cookware lines, and the cookware items within those lines, with buttons or checkboxes that the consumer can click on to enter the new cookware purchased. The pictorial presentation of other cookware items in the purchased product line may also encourage the consumer to make an additional purchase, and links to purchase other items on the vender's website can be provided within the vender application and displayed to the consumer during the redemption process.

At 240, the vender application receives the consumer personal and purchase data and stores the data in a database. Then the vender application generates a unique redemption identifier (e.g., a barcode) that identifies and is associated with the consumer data and the purchase data. The vender application may be designed to track multiple purchases for an individual consumer and use this data in the assignment of an appropriate bonus item. The vender application also generates a mailing label for use by the consumer in returning the used cookware for recycling. The mailing label displays the unique redemption identifier assigned to the personal and purchase data. The mailing label and integral redemption identifier are then sent to the consumer's computer by the vender application and may be printed to hardcopy by a conventional printer. The vender website, vender application, and vender database can employ any suitable infrastructure and communication protocols as are well-known in the field of online commerce.

In an alternative embodiment of the present invention, the consumer can be supplied a redemption questionnaire card in the new cookware retail package. The consumer completes the redemption questionnaire card and mails the card to the vender. The vender receives the redemption card and generates a mailing label and a unique redemption identifier for the consumer. The mailing label, with the integral redemption identifier, is then mailed back to the consumer's address. In this embodiment, consumers without computer skills and/or Internet access can participate in the cookware recycling program.

At 250, the consumer places the used cookware for recycling into the original retail package that contained the new cookware. The vender application previously recorded the new product purchased by the consumer and referenced the size of the retail carton that contained the product. As the size of the various retail packages of new vender products vary, the vender application can be designed to provide customized instructions relative to the size and configuration of the retail packaging of the new cookware purchased. The original retail package includes packaging materials such as dividers and/or baffles that aid in the packing of the used cookware for recycling into the retail package. In one embodiment, the dividers and/or baffles are scored or otherwise formed with into frangible panels, blocks, or other components so that they can be modified/reconfigured for use in repackaging the old cookware into the retail packaging. In another embodiment, the original retail package includes loose-fill packaging materials such as plastic peanuts that are used to securely package the new cookware and that can be used to securely package the old cookware in the retail packaging, even in cases where the new and used cookware are very different in size and shape. In addition, the original retail package can include a return mailing label (addressed to the vender-designated recycling facility) and re-sealing materials such as packing tape. In any event, the consumer packs and seals the retail package (e.g., per customized instructions provided by the vender application for the retail package type). The consumer then affixes the mailing label and integral redemption identifier to the retail package at an appropriate location on the package (e.g., per instructions provided by the vender application). Based on the retail package size and the quantity/size of used cookware to be returned for recycling, the consumer may choose to provide their own shipping package for returning the used cookware to the vender facility. The vender application can provide some minimal instructions and/or requirements for customer-supplied packaging.

At 260, the consumer ships the used cookware to the vender recycling facility identified by the shipping label. In the redemption process, the consumer is given a choice of a preferred shipping method by the vender application. The shipping choices provided to the consumer can include U.S. mail, commercial carriers such as FedEx, UPS, or Airborne, or other shipping companies designated by the vender. The consumer can choose the shipping method based in part on the availability of a convenient drop-off location for a particular carrier.

At 270, the consumer receives a bonus item or a notification that the returned cookware was not in compliance with requirements of the recycling program, as described herein. The bonus item is received from the vender-designated facility directly or from a third-party facility upon the instructions of the vender facility. The bonus item can be a preferred bonus item selected by the consumer or another bonus item, as described herein. As such, the recycling process transforms the used cookware into a bonus item having value.

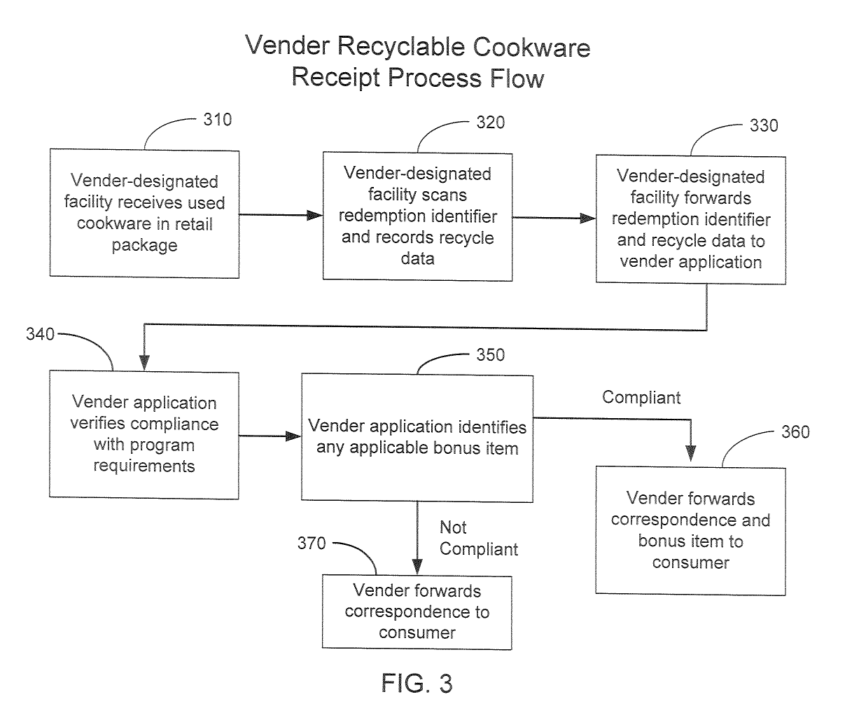

The process of the receipt of the used cookware by the vender is presented in FIG. 3, which is a flow diagram depicting vender actions in accordance with a recycling process of an example embodiment. At 310, the retail package is received at the vender-designated facility. The facility may be operated by the new cookware vender or by a third-party vender.

At 310, the vender-designated facility records (e.g., scans, manually types, handwrites a note) the unique redemption identifier from the retail package. The vender facility then determines certain recycle data of the used cookware returned for recycling. The recycle data includes the weight of the used cookware and/or the weight of the combined retail package and used cookware (with the weight of the carton for the new cookware item being pre-entered by the vender in the vender application, the approximate weight of the used cookware can be determined based on the weight of the combined retail package and used cookware). The recycle data can also include the quantity of used cookware items returned, the new cookware item purchased (as reflected by the retail packaging), the brand of the used cookware returned for recycling, the type of used cookware returned for recycling, and/or the basic metals from which each used cookware item is made. Then at 330, the vender facility forwards the redemption identifier and the recycle data to the vender application via a suitable communication infrastructure and protocol.

At 340, the vender application receives the redemption identifier and the recycle data, and compares the recycle data to the recycling program requirements to determine if the used cookware returned is in compliance with the program requirements. The recycling program requirements for eligibility for a bonus item can include a minimum weight or quantity of used cookware, only cookware made of specified metal types, a minimum purchase price of the new cookware, and/or only specified new cookware items, lines, and/or brands purchased.

At 350, if the used cookware returned is in compliance, then the vender application determines an applicable bonus item. The vender application can select the bonus item to be the preferred bonus item selected by the consumer and stored in the personal data associated with the redemption identifier. In addition, the vender application can be designed to permit the consumer to select multiple bonus items ranked by preference, so that if the most-preferred bonus item is out of stock or no longer offered, then the vender application selects the next-ranked bonus item selected by the consumer. The recycling program can also have a cost or price range of bonus items available depending on the value (e.g., by weight or metal type) of the used cookware returned. Alternatively, the size or type of bonus item can be selected by the vender application based on the recycle data. For example, if the consumer has chosen to receive a non-retail cookware item, the bonus items can be trivets cast from the metal of previously recycled cookware. Trivets may be available in small, medium, and large, and embossed with the trademark of the vender. The vender application may select either the small, medium, or large trivet based upon the weight of recyclable cookware returned. Alternatively, if the consumer primarily returned cookware made of one metal (e.g., aluminum or cast iron) for recycling, the vender application can select a bonus item constructed of that same metal. The bonus item can be an ingot of the metal, which the consumer then takes to a local recycling center for redemption. As such, the recycling process transforms the used cookware into a bonus item having value to the consumer.

The vender application then generates correspondence (e.g., email or a letter) to the consumer. The correspondence informs the consumer whether the returned cookware was in compliance. In addition, the correspondence can note the new cookware item purchased and the weight of recyclable materials returned, and thank the consumer for participation in the program. The correspondence can also include an advertisement (e.g., a flyer or brochure) of other products available from the vender such as products relevant to the new cookware product purchased. For example, the other cookware products advertised can be within the same product line or they can be accessories for use with the new cookware product purchased.

At 360, if the used cookware returned is in compliance, then the correspondence and the bonus item are sent to the consumer. The correspondence and the bonus item need not come from the same vender-designated facility, and the vender application may direct third-party facilities (e.g., off-site warehouses or other storage facilities) to ship the bonus items and/or correspondence to the consumers' addresses independently.

At 370, if the used cookware returned is not in compliance, then a bonus item is not sent to the consumer. Instead the vender application sends correspondence to the consumer noting why the used cookware returned did not comply with the recycling program requirements.

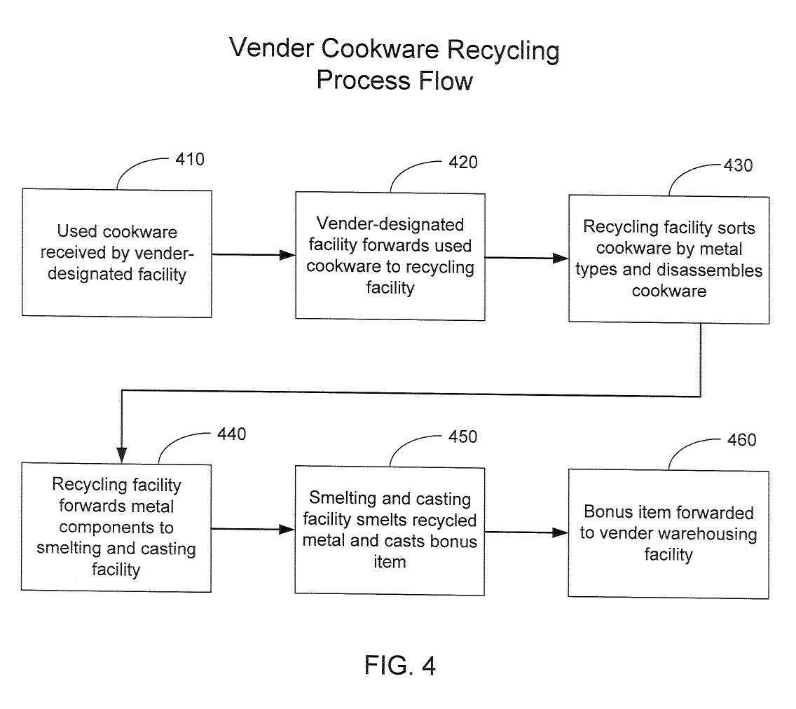

The process of recycling the used cookware by the vender is presented in FIG. 4, which is a flow diagram depicting further vender-related actions in a cookware recycling process in accordance with an example embodiment. At 410, the used cookware is received at the vender-designated facility in the retail package. The vender-designated facility can be operated by the vender or by a third party. The vender-designated facility then records the redemption identifier and determines and records the recycle data as discussed above. At 420, the vender-designated facility forwards the used cookware to a third-party recycling facility. In an alternative embodiment, the vender-designated facility that receives the retail package can itself be a third-party recycling facility. At 430, the recycling facility deconstructs/disassembles the returned cookware into primary metal components. For example, steel or alloy handles can be removed from aluminum cookware vessels. The metal types are then sorted and any scrap or unrecyclable material is identified and disposed of.

At 440, the sorted metal components are forwarded to one or more third-party smelting and casting facilities. The smelting and casting facility can be integral to the recycling facility or it can be a third-party facility. At 450, the smelting facility smelts each metal type in preparation for casting or otherwise forming new objects. At the direction of the vender, new cookware product components can be cast for use as bonus items from a portion of the recycled metals. The remaining recycled metal is sold for use in other objects. At 460, the cast component is subjected to any post-casting finishing operations or surface treatments, and a bonus item can be assembled from the cast components (e.g., the bonus item can be a cookware item formed from the used cookware metal). The bonus item is then forwarded to a vender warehousing facility for future distribution to consumers participating in the program. As such, an individual consumer may receive a bonus cookware item not made of the material smelted from the used cookware returned. Instead, the bonus cookware item might be made from material smelted from used cookware returned by another consumer. The smelting step transforms the used cookware to reuseable metallic materials, and the casting step transforms the reuseable metallic materials to new objects such as cookware, cookware components, trivets, ingots, and/or the like.

As can be readily seen, the recycling effort by the consumer can be triggered by the purchase of new cookware. The recycling program can provide a ready means of packaging and shipping the old cookware to the recycling facility. In this way, the consumer is not burdened by travel to a metal recycling center, but instead the recycling program facilitates the shipment of used cookware to the metal recycling facility from the consumers' home. The consumer receives a thank you note from the recycler or a bonus item is awarded for the recycling effort.

It is to be understood that this invention is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the claimed invention has been shown and described in example forms, it will be apparent to those skilled in the art that many modifications, additions, and deletions can be made therein without departing from the spirit and scope of the invention as defined by the following claims.

What is claimed is:

1. A cookware recycling method, comprising:
a cookware user purchasing at least one new cookware item that is offered by a vender and provided in a vender retail package;
the cookware user removing the new cookware item from the vender retail package;
the cookware user packaging at least one recyclable cookware item in the vender retail package;
the cookware user shipping the recyclable cookware item in the vender retail package to a vender-designated recycling facility;
the vender-designated facility receiving the recyclable cookware item in the vender retail package; and
the vender forwarding a bonus item to the cookware user.

2. The method of claim 1, wherein the cookware user shipping the recyclable cookware item to the vender-designated facility comprises:
the cookware user accessing a vender website using a communications network;
the cookware user entering personal data and purchase data relevant to the purchase of the new cookware item into a vender application of the vender website;
the vender application assigning a unique redemption identifier to the personal data and the purchase data, storing the personal data, the purchase data, and the redemption identifier in a vender database, and sending the redemption identifier to the cookware user;
the cookware user receiving the redemption identifier; and
the cookware user affixing the redemption identifier and a shipping label onto the vender retail package.

3. The method of claim 2, wherein the cookware user receiving the unique redemption identifier comprises the cookware user receiving and printing the unique redemption identifier and the shipping label from the vender application.

4. The method of claim 2, wherein the unique redemption identifier comprises at least one of an alpha-numerical number, a barcode, and a combined alpha-numeric number and barcode.

5. The method of claim 2, wherein the personal data comprises a selection of the bonus item.

6. The method of claim 5, wherein the selection of the bonus item is made from the bonus item group comprising:
cash money;
a tax receipt for a value of the recyclable material;
a coupon useable toward future purchases of vender cookware items;
a special non-retail vender cookware item;
a vender cookware or cookware accessory item made from a metal of the recyclable cookware;
an ingot made from the metal of the recyclable cookware; and
a non-cookware recycling-related gift.

7. The method of claim 2, wherein the purchase data comprises a model number of the new cookware item purchased.

8. The method of claim 2, wherein the vender-designated facility receiving the recyclable cookware item comprises:
entering the redemption identifier on the retail package into the vender application;
obtaining recycle data relevant to the recyclable cookware item and the retail package;
entering the recycle data into the vender application; and
the vender application verifying compliance by comparing the recycle data and program requirements.

9. The method of claim 8, wherein the recycle data comprises at least one of:
verification of the recyclable cookware item being present in the retail package;
measured weight of the recyclable cookware item;
measured weight of the combined retail package and recyclable cookware item;
metal type of the recyclable cookware item in the retail package;
brand of the recyclable cookware item in the retail package; and
type of the recyclable cookware item in the retail package; and
model number of the new cookware item purchased as indicated on the retail package.

10. The method of claim 2, wherein the vender forwarding a bonus item to the cookware user comprises the vender application retrieving the bonus item selection stored in the database.

11. The method of claim 10, wherein the vender forwarding a bonus item to the cookware user further comprises:
smelting the recyclable cookware item;
forming the smelted metal into a new metal object; and
shipping the metal object to the cookware user as the bonus item.

12. A cookware recycling method, comprising:
a cookware user purchasing at least one new cookware item that is offered by a vender and provided in a vender retail package;
the cookware user removing the new cookware item from the vender retail package;
the cookware user packaging at least one recyclable cookware item in the vender retail package;
the cookware user accessing a vender website using a communications network;
the cookware user entering personal data and purchase data relevant to the purchase of the new cookware item into a vender application of the vender website;
the vender application assigning a unique redemption identifier to the personal data and the purchase data, storing the personal data, the purchase data, and the redemption identifier in a vender database, and sending the redemption identifier to the cookware user;
the cookware user receiving the unique redemption identifier; and
the cookware user affixing the unique redemption identifier and a shipping label onto the vender retail package;
the cookware user shipping the recyclable cookware item in the vender retail package to a vender-designated recycling facility;
the vender-designated facility receiving the recyclable cookware item in the retail package;
the vender-designated facility entering the redemption identifier on the retail package into the vender application;
the vender-designated facility obtaining recycle data relevant to the recyclable cookware and the retail package;
the vender-designated facility entering the recycle data into the vender application;
the vender application verifying compliance by comparing the recycle data and program requirements; and
if compliant, the vender forwarding a bonus item to the cookware user.

13. The method of claim 12, wherein the cookware user receiving the unique redemption identifier comprises the cookware user receiving and printing the unique redemption identifier and the shipping label from the vender application.

14. The method of claim 12, wherein the personal data comprises a selection of the bonus item from the bonus item group comprising:
cash money;
a tax receipt for a value of the recyclable material;
a coupon useable toward future purchases of vender cookware items;
a special non-retail vender cookware item;
a cookware item made from a metal of the recyclable cookware;
an ingot made from the metal of the recyclable cookware; and
a non-cookware recycling-related gift.

15. The method of claim 14, wherein the vender forwarding a bonus item to the cookware user comprises the vender application retrieving the bonus item selection stored in the database.

16. The method of claim 14, wherein the vender forwarding a bonus item to the cookware user further comprises:
smelting the recyclable cookware item;
forming the smelted metal into a new metal object; and
shipping the metal object to the cookware user as the bonus item.

17. The method of claim 12, wherein the recycle data comprises at least one of:
verification of the recyclable cookware item being present in the retail package;
measured weight of the recyclable cookware item;
measured weight of the combined retail package and recyclable cookware item;
metal type of the recyclable cookware item in the retail package;
brand of the recyclable cookware item in the retail package; and
type of the recyclable cookware item in the retail package; and
model number of the new cookware item purchased as indicated on the retail package.

18. A computer-network-implemented method of recycling cookware in which a cookware user purchases a new vender cookware item in a vender retail package, removes the new vender cookware item from the retail package, packages a recyclable cookware item in the retail package, and sends the recyclable cookware item and the retail package to a vender-designated facility for processing, the method comprising:
receiving from the cookware user personal data and purchase data relevant to the purchase of the new cookware item;
assigning a unique redemption identifier to the personal data and the purchase data;
storing the personal data, the purchase data, and the redemption identifier in a vender database;
providing the cookware user with the redemption identifier and with a mailing label addressed to the vender-designated recycling facility for placement on the retail package containing the recyclable cookware item;
receiving from the vender-designated facility the redemption identifier on the retail package;
receiving from the vender-designated facility recycle data relevant to the recyclable cookware and the retail package;
retrieving the personal data and the purchase data stored in the vender database;
verifying compliance by comparing the recycle data and program requirements; and
if compliant, sending to the vender-designated facility or another vender facility instructions for shipping a bonus item to the cookware user.

19. The method of claim 18, wherein providing the cookware user with the redemption identifier and with a mailing label comprises:
generating the unique redemption identifier;
generating the mailing label including the redemption identifier and an address for the vender-designated recycling facility; and
sending the mailing label to the cookware user.

20. The method of claim 18, wherein receiving from the cookware user personal data and purchase data includes receiving from the cookware a selection of the bonus item, and wherein retrieving the personal data and the purchase data includes retrieving the bonus item selection stored in the database.

21. The method of claim 20, wherein receiving from the cookware user a selection of the bonus item includes receiving the selection of the bonus item from the bonus item group comprising:
cash money;
a tax receipt for a value of the recyclable material;
a coupon useable toward future purchases of vender cookware items;
a special non-retail vender cookware item;
a cookware item made from a metal of the recyclable cookware;
an ingot made from the metal of the recyclable cookware; and
a non-cookware recycling-related gift.

22. The method of claim 18, wherein the recycle data comprises at least one of:
verification of the recyclable cookware item being present in the retail package;
measured weight of the recyclable cookware item;
measured weight of the combined retail package and recyclable cookware item;
metal type of the recyclable cookware item in the retail package;
brand of the recyclable cookware item in the retail package; and
type of the recyclable cookware item in the retail package; and
model number of the new cookware item purchased as indicated on the retail package.

23. The method of claim 18, wherein sending the instructions for shipping a bonus item to the cookware user comprises sending to the vender-designated facility or another vender facility instructions for:
smelting the recyclable cookware item;
forming the smelted metal into a new metal object; and
shipping the metal object to the cookware user as the bonus item.

24. A computer-readable storage device storing computer-executable instructions for performing the method of claim 18.

25. A server computer or bank of server computers connected to a computer network and storing computer-executable instructions for performing the method of claim 18.
